(19) United States
(12) Patent Application Publication
(10) Pub. No.: US 2011/0216984 A1
(43) Pub. Date: Sep. 8, 2011

(54) IMAGE DENOISING DEVICE, IMAGE DENOISING METHOD, AND IMAGE DENOISING PROGRAM

(76) Inventor: Tadanori Tezuka, Fukuoka (JP)

(21) Appl. No.: 12/674,197

(22) PCT Filed: Aug. 7, 2008
(86) PCT No.: PCT/JP2008/002141

§ 371 Date: Feb. 19, 2010

(30) Foreign Application Priority Data
Sep. 20, 2007 (JP) 2007-243225

(51) Int. Cl. G06K 9/40

(52) U.S. Cl. 382/260

(57) ABSTRACT

A gradient direction detection unit 12 detects a gradient direction of values of pixels contained in an area consisting of N×N pixels including a target pixel at the center of the area, where N is an odd number no less than 3; a selecting unit 13 selects N pixels as selection pixels from among the N×N pixels in a direction orthogonal to the gradient direction, the selection pixels including the target pixel; a filter coefficient initialization unit 14 initializes filter coefficients corresponding to the selection pixels respectively; a reference value determination unit 15 determines, for each of the selection pixels, a reference value for correction of the corresponding filter coefficient, based on pixel values of pixels determined by the gradient direction; a filter coefficient correction unit 16 corrects, for each of the selection pixels, an initial value of the corresponding filter coefficient, based on the corresponding reference value; and a pixel value calculation unit calculates an output pixel value of the target pixel, based on pixel values of the selection pixels and corrected values of the filter coefficients.

### TECHNICAL FIELD

The present invention relates to a technology to remove noise contained in an image.

### BACKGROUND ART

In recent years, with digitization of imaging apparatuses, image processing using digital signal processing technologies has been getting more important for improvement of image quality. One factor for image quality degradation is noise contained in an original signal. To improve the image quality, it is important to remove the noise or to reduce the influence of the noise.

As a means for removing noise from the original signal, a filter called a median filter is well known. The median filter extracts a target pixel and neighboring pixels thereof from the original image, and outputs, as the output pixel value of the target pixel, the pixel value of the pixel having the middle brightness value among the brightness values of the extracted pixels (i.e. the target pixel and the neighboring pixels) arranged in ascending or descending order. In general, the brightness values of nine pixels, namely 3×3 pixels including a target pixel and neighboring pixels, are arranged in ascending or descending order, and the pixel value of the pixel having the 5^{th} brightness value (i.e. the middle brightness value) is determined as the output pixel value of the target pixel. As a result, a pixel having a pixel value that is significantly different from those of its surrounding pixels (i.e. a pixel that appears to be noise) will be removed, and an image containing reduced noise will be obtained.

However, since the pixel value of the pixel having the middle brightness value is determined as the output pixel value of the target pixel as explained above, the median filter has a problem that the image will be blurred by the denoising. This is particularly prominent around the edges of the image. The median filter also has a problem that it can not perform sufficient denoising if a large amount of noise is contained in the image.

Another means for removing noise, which resolves the problems above, is a bilateral filter. The bilateral filter is a type of edge-preserving filter, which performs denoising while preserving the edges of an image. The bilateral filter focuses on the distance from the target pixel and the difference in brightness from the target pixel, and preserves the edges of an image by reducing the influence of a pixel having a brightness value that is significantly different from the brightness value of the target pixel, or a pixel that is distant from the target pixel. The bilateral filter is described in detail in the Background Art section of Patent Literature 1. The following outlines the functions of the bilateral filter with citations from the Patent Literature 1.

The bilateral filter extracts, as a filtering-target area, (2N+1)×(2N+1) pixels that include a target pixel and neighboring pixels thereof, and performs filtering processing on the filtering-target area. The bilateral filter obtains the output pixel value of the target pixel through the filtering processing, and outputs the obtained value.

The bilateral filter performs the filtering processing as follows. Note that the coordinates of the target pixel are denoted by (X, Y), the pixel value of the target pixel is denoted by IN (X, Y), the output pixel value of the target pixel is denoted by OUT (X, Y), and the coordinates of a neighboring pixel of the target pixel are denoted by (PX, PY).

In the case where a value that is dependent on the distance between the target pixel (X, Y) and the neighboring pixel (PX, PY) is Ws (X, Y, PX, PY), and the standard deviation between the target pixel (X, Y) and the neighboring pixel (PX, PY) is σₛ, the value Ws (X, Y, PX, PY) is expressed by the expression (1) below.

$$\begin{matrix}[ Math . 1 ] & \\ Ws ( X , Y , PX , PY ) = {e}^{- \frac{{( X - PX )}^{2} + {( Y - PY )}^{2}}{2 {σ}_{s}^{2}}} & ( 1 )\end{matrix}$$

In the case where an edge evaluation value, which shows presence or absence of an edge, is Wr(X, Y, PX, PY), the edge evaluation value Wr (X, Y, PX, PY) is expressed by the expression (2) below.

$$\begin{matrix}[ Math . 2 ] & \\ Wr ( X , Y , PX , PY ) = {e}^{- \frac{{\{ Edge ( X , Y ) - Edge ( PX , PY ) \}}^{2}}{2 {σ}_{r}^{2}}} & ( 2 )\end{matrix}$$

Note that Edge (X, Y) denotes the pixel value of the target pixel (X, Y), Edge (PX, PY) denotes the pixel value of the neighboring pixel (PX, PY), and σₛ denotes the standard deviation among the pixel values of the pixels contained in the filtering-target area.

A coefficient W (X, Y, PX, PY) is obtained by substituting the value Ws (X, Y, PX, PY) obtained by the expression (1) and the edge evaluation value Wr (X, Y, PX, PY) obtained by the expression (2) into the following expression (3).

[Math. 3]

W(X, Y, PX, PY)=Ws(X, Y, PX, PY)×Wr(X, Y, PX, PY) (3)

The output pixel value OUT(X, Y) of the target pixel is obtained by the following expression (4).

$$\begin{matrix}[ Math . 4 ] & \\ OUT ( X , Y ) = \frac{{\sum }_{PX = X - n}^{X + n} {\sum }_{PY = Y - n}^{Y + n} W ( X , Y , PX , PY ) \times IN ( X , Y )}{{\sum }_{PX = X - n}^{X + n} {\sum }_{PY = Y - n}^{Y + n} W ( X , Y , PX , PY )} & ( 4 )\end{matrix}$$

### Patent Literature 1: Japanese Patent Application Publication No. 2006-180268

### DISCLOSURE OF INVENTION

### Technical Problem

However, in the filtering processing with the bilateral filter, it is necessary to perform the calculations by the expressions (1)-(4). Further, it is necessary to increase the value of N to some extent, because the denoising, etc. does not become fully effective if the value of N is not large enough. Thus, the bilateral filter has a problem that the required amount of calculations for the denoising is large.

The present invention has been achieved in view of the above problems, and an aim thereof is to provide an image denoising device, an image denoising method and an image denoising program that are capable of effectively performing the denoising while preserving the edges of an image, with simple calculations.

### Technical Solution

In order to solve the above problems, one aspect of the present invention provides an image denoising device comprising: a gradient direction detection unit operable to detect a gradient direction of values of pixels contained in an area consisting of N×N pixels including a target pixel at the center of the area, where N is an odd number no less than 3; a selecting unit operable to select N pixels as selection pixels from among the N×N pixels in a direction orthogonal to the gradient direction, the selection pixels including the target pixel; a filter coefficient initialization unit operable to initialize filter coefficients respectively corresponding to the selection pixels; a reference value determination unit operable to determine, for each of the selection pixels, a reference value for correction of the corresponding filter coefficient, based on pixel values of pixels determined by the gradient direction; a filter coefficient correction unit operable to correct, for each of the selection pixels, an initial value of the corresponding filter coefficient, based on the corresponding reference value; and a pixel value calculation unit operable to calculate an output pixel value of the target pixel, based on pixel values of the selection pixels and corrected values of the filter coefficients.

Another aspect of the present invention is an image denoising method comprising: a gradient direction detection step of detecting a gradient direction of values of pixels contained in an area consisting of N×N pixels including a target pixel at the center of the area, where N is an odd number no less than 3; a selecting step of selecting N pixels as selection pixels from among the N×N pixels in a direction orthogonal to the gradient direction, the selection pixels including the target pixel; a filter coefficient initialization step of initializing filter coefficients respectively corresponding to the selection pixels; a reference value determination step of determining, for each of the selection pixels, a reference value for correction of the corresponding filter coefficient, based on pixel values of pixels determined by the gradient direction; a filter coefficient correction step of correcting, for each of the selection pixels, an initial value of the corresponding filter coefficient, based on the corresponding reference value; and a pixel value calculation step of calculating an output pixel value of the target pixel, based on pixel values of the selection pixels and corrected values of the filter coefficients.

Another aspect of the present invention is an image denoising program for causing a computer to perform: a gradient direction detection step of detecting a gradient direction of values of pixels contained in an area consisting of N×N pixels including a target pixel at the center of the area, where N is an odd number no less than 3; a selecting step of selecting N pixels as selection pixels from among the N×N pixels in a direction orthogonal to the gradient direction, the selection pixels including the target pixel; a filter coefficient initialization step of initializing filter coefficients respectively corresponding to the selection pixels; a reference value determination step of determining, for each of the selection pixels, a reference value for correction of the corresponding filter coefficient, based on pixel values of pixels determined by the gradient direction; a filter coefficient correction step of correcting, for each of the selection pixels, an initial value of the corresponding filter coefficient, based on the corresponding reference value; and a pixel value calculation step of calculating an output pixel value of the target pixel, based on pixel values of the selection pixels and corrected values of the filter coefficients.

### Advantageous Effects

With the image denoising device having the stated structure, it is possible to effectively perform the denoising while preserving the edges of an image, with simple calculations.

In the image denoising device having the stated structure, for each of the selection pixels, the reference value determination unit may select a plurality of pixels based on the gradient direction, and determine the corresponding reference value based on pixel values of the selected pixels.

With this structure, the reference value for each selection pixel, used for correction of the corresponding filter coefficient, is determined based on pixel values of a plurality of pixels. Thus the image denoising device is capable of correcting the filter coefficients while suppressing the influence of noise.

In the image denoising device having the stated structure, for each of the selection pixels except the target pixel, the reference value determination unit may select a plurality of pixels based on the gradient direction, and determine the corresponding reference value based on pixel values of the selected pixels, and for the target pixel as one of the selection pixels, the reference value determination unit may determine the corresponding reference value based on a pixel value of the target pixel.

With this structure, the pixel value of the target pixel (i.e. one of the selection pixels) is used as the reference value for correction of the filter coefficient corresponding to the target pixel. Also, the reference value for each selection pixel (except the target pixel), used for correction of the corresponding filter coefficient, is determined based on pixel values of a plurality of pixels. Thus the image denoising device is capable of correcting the filter coefficients with a reduced amount of calculations.

In the image denoising device having the stated structure, for each of the selection pixels, the reference value determination unit may use the corresponding pixel value as the corresponding reference value.

With this structure, the image denoising device is capable of correcting the filter coefficients with a reduced amount of calculations.

### BRIEF DESCRIPTION OF DRAWINGS

FIG. 1 shows the structure of a denoising device 1 pertaining to an embodiment of the present invention.

FIG. 2 shows the structure of a denoising unit 4 shown in FIG. 1.

FIG. 3 shows an example relationship between a target pixel and neighboring pixels, to be processed by the denoising unit 4 shown in FIG. 2.

FIG. 4 shows gradient directions in the case of 3×3 pixels, which can be detected by a gradient direction detection unit 12 shown in FIG. 2.

FIG. 5 shows gradient directions in the case of 5×5 pixels, which can be detected by the gradient direction detection unit 12 shown in FIG. 2.

FIGS. 6A-6D each show selection pixels in the case of 3×3 pixels, to be selected by a selecting unit 13 shown in FIG. 2.

FIGS. 7A-7D each show selection pixels in the case of 5×5 pixels, to be selected by the selecting unit 13 shown in FIG. 2.

FIGS. 8A-8D illustrate determination of reference values for selection pixels in the case of 3×3 pixels, performed by a reference value determination unit 15 shown in FIG. 2.

FIGS. 9A-9D illustrate determination of reference values for selection pixels in the case of 5×5 pixels, performed by the reference value determination unit 15 shown in FIG. 2.

FIG. 10 is a graph showing coefficient correction values used by a filter coefficient correction unit 16 shown in FIG. 2, for correction of filter coefficients.

FIG. 11 illustrates correction of filter coefficients in the case of 3×3 pixels, performed by the filter coefficient correction unit 16 shown in FIG. 2.

FIG. 12 illustrates correction of filter coefficients in the case of 5×5 pixels, performed by the filter coefficient correction unit 16 shown in FIG. 2.

FIG. 13 is a flowchart showing procedures for denoising processing performed by a noise denoising unit 4 shown in FIG. 2.

FIG. 14 shows the structure of a computer as a modification of the present invention.

FIGS. 15A-15C illustrate example applications of denoising processing on a color image.

### EXPLANATION OF REFERENCE

1 image denoising device

2 original-image memory

3 processed-image memory

4 denoising unit

11 pixel value acquisition unit

12 gradient direction detection unit

13 selecting unit

14 filter coefficient initialization unit

15 reference value determination unit

16 filter coefficient correction unit

17 pixel value calculation unit

18 pixel value output unit

### BEST MODE FOR CARRYING OUT THE INVENTION

An embodiment of the present invention is described below with reference to the drawings.

### <<Structure of Image Denoising Device 1>>

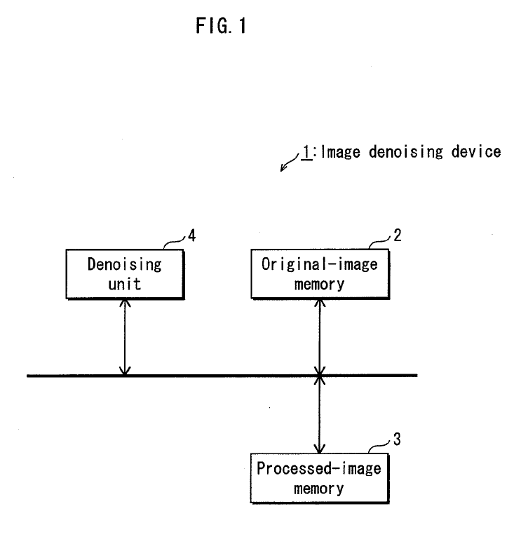

The following describes an image denoising device 1 pertaining to an embodiment of the present invention, with reference to FIG. 1. FIG. 1 shows the structure of the image denoising device 1.

The image denoising device 1 includes an original-image memory 2, a processed-image memory 3, and a denoising unit 4.

Note that the original-image memory 2 and the processed-image memory 3 may be logical memories for example, and thus they may be embodied on the same physical memory.

As the original-image memory 2 and the processed-image memory 3, for example a semiconductor memory is used. The original-image memory 2 stores an original image that has not been subject to denoising processing. The processed-image memory 3 stores a processed image that has been subject to denoising processing performed by the noise denoising unit 4. The denoising unit 4 performs denoising processing on an original image stored in the original-image memory 2, and writes a processed image, obtained as the result of the denoising processing, into the processed-image memory 3.

### <Structure of Denoising Unit 4>

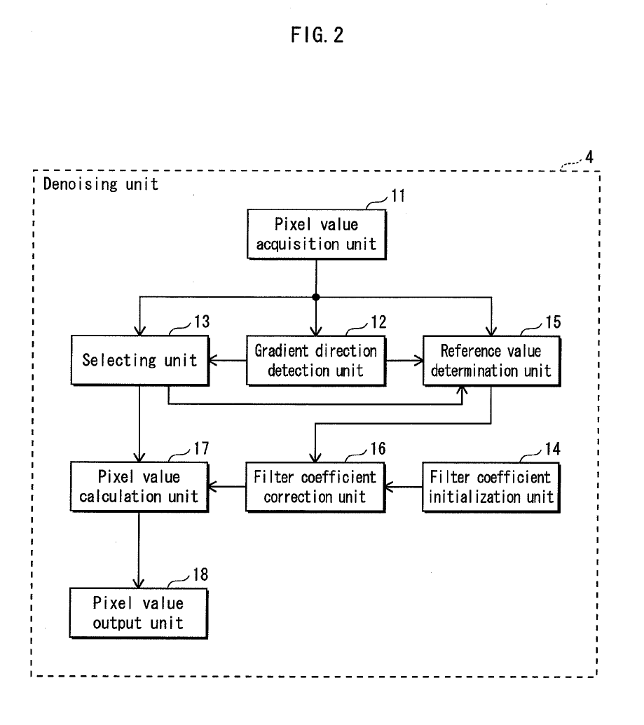

The following describes the structure of the denoising unit 4 shown in FIG. 1, with reference to FIG. 2. FIG. 2 shows the structure of the denoising unit 4 shown in FIG. 1.

The denoising unit 4 includes a pixel value acquisition unit 11, a gradient direction detection unit 12, a selecting unit 13, a filter coefficient initialization unit 14, a reference value determination unit 15, a filter coefficient correction unit 16, a pixel value calculation unit 17 and a pixel value output unit 18.

The pixel value acquisition unit 11 acquires, from the original-image memory 2, the pixel values of the pixels contained in an area of N×N pixels (N is an odd number no less than 3), including the target pixel at the center. The pixel value acquisition unit 11 then outputs the acquired pixel values to the gradient direction detection unit 12, the selecting unit 13 and the reference value determination unit 15. Note that the pixels contained in the area of N×N pixels except the target pixel are referred to as “neighboring pixels”, and an area of the original image, consisting of the target pixel and the neighboring pixels, is referred to as “a target area”.

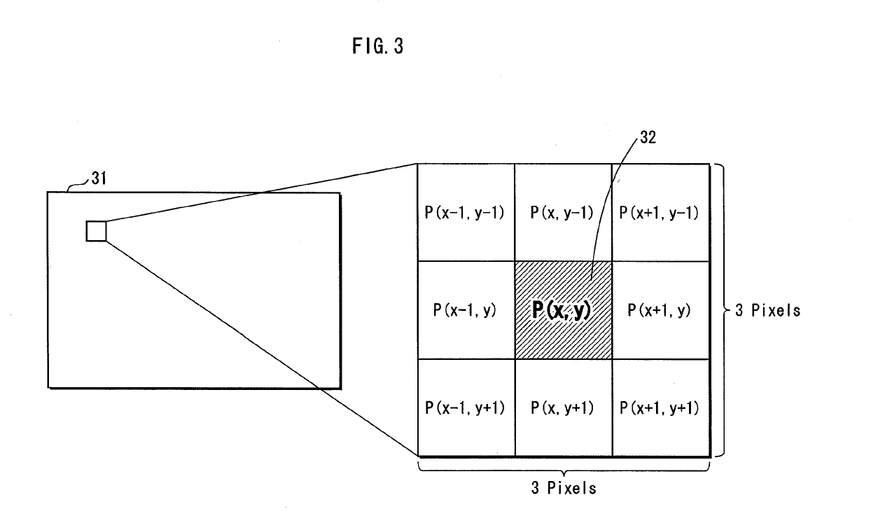

FIG. 3 shows the relationship between the target pixel and the neighboring pixels in the case where the target area consists of 3×3 pixels. In the case where a pixel P(x, y) in an original image 31 is a target pixel 32, pixels represented by P(x+i, y+j) (i is an integer no less than −1 and no greater than 1, j is an integer no less than −1 and no greater than 1, and the cases where i and j are both 0 should be excluded), surrounding the target pixel 32, are the neighboring pixels. In the case where the target area consists of 5×5 pixels, when the pixel P(x, y) in the original image 31 is the target pixel 32, pixels represented by P(x+i, y+j) (i is an integer no less than −2 and no greater than 2, j is an integer no less than −2 and no greater than 2, and the cases where i and j are both 0 should be excluded), surrounding the target pixel 32, are the neighboring pixels. In view of the denoising performance and the processing amount for the denoising, it is preferable that the target area consists of 3×3 pixels or 5×5 pixels.

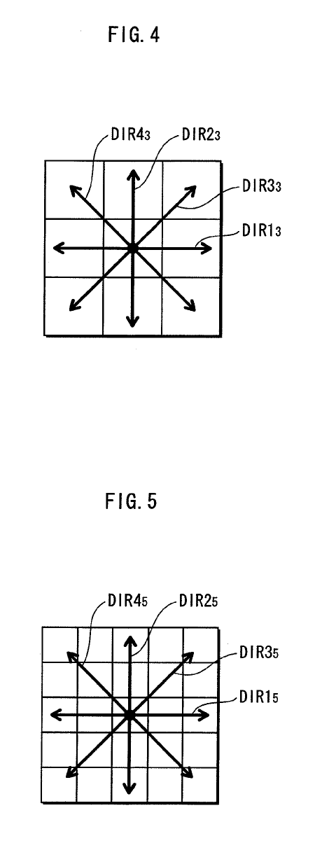

The gradient direction detection unit 12 detects a gradient direction of the pixel values of the pixels in a target area, based on the pixels values input from the pixel value acquisition unit 11. The gradient direction detection unit 12 outputs the detected gradient direction to the selecting unit 13 and the reference value determination unit 15. Note that the gradient direction detected by the gradient direction detection unit 12 pertaining to this embodiment is one of a plurality of predetermined gradient directions that is the closest to a gradient direction actually calculated from the pixel values. FIG. 4 shows gradient directions that can be detected by the gradient direction detection unit 12 in the case where the target area consists of 3×3 pixels. From among gradient directions DIR1₃-DIR4₃, the gradient direction detection unit 12 detects one that is the closest to a gradient direction actually calculated from the pixel values. FIG. 5 shows gradient directions that can be detected by the gradient direction detection unit 12 in the case where the target area consists of 5×5 pixels. From among gradient directions DIR1₅-DIR4₅, the gradient direction detection unit 12 detects one that is the closest to a gradient direction actually calculated from the pixel values. In this embodiment, each of the gradient directions DIR1₃-DIR4₃ and each of the gradient directions DIR1₅-DIR4₅ includes two direction, namely a direction and the opposite direction.

Note that a Sobel filter or a Prewitt filter may be used as the gradient direction detection unit 12. These filters are often used for edge detection. Sobel filters and Prewitt filters calculate the horizontal gradient and the vertical gradient by 3×3 matrix operations. Using two filter coefficients, each filter acquires the horizontal gradient and the vertical gradient. Sobel filters and Prewitt filters detect the gradient direction of the pixel values based on the acquired horizontal and vertical gradients.

The gradient direction of the pixel values in the target area may be detected based on the method disclosed in Japanese Patent Application Publication No. 2001-14461. If this is the case, the direction to be acquired based on the method is tangential to the gradient that is orthogonal to the gradient of the pixel values. Thus, it is necessary to perform conversion from the direction orthogonal to the detected direction into the gradient direction to be detected by the gradient direction detection unit 12.

A detection unit used for the detection of the gradient direction mentioned above will not be explained in detail, because it is well-known. Note that the detection unit mentioned above is only an example. Any means may be used as long as it can detect the gradient direction of the pixel values.

Based on the gradient direction of the pixel values in the target area received from the gradient direction detection unit 12, the selecting unit 13 selects, from a plurality of pixels contained in the target area, N pixels including the target pixel, in the direction orthogonal to the gradient direction. The selecting unit 13 outputs the pixel values of the selected pixels to the pixel value calculation unit 17, while outputting selection-pixel information, which indicates the selected pixels, to the reference value determination unit 15. More specifically, the selecting unit 13 selects N pixels including the target pixel, existing in the line that passes through the center point of the target pixel and is orthogonal to the gradient direction. The pixels selected by the selecting unit 13 are hereinafter called “selection pixels”.

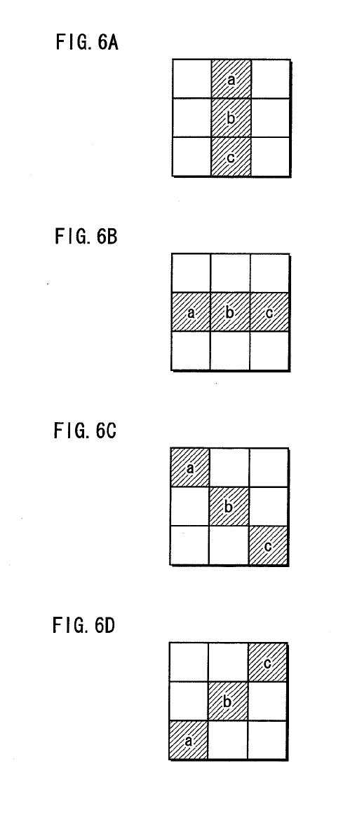

FIGS. 6A to 6D show the selection pixels to be selected by the selecting unit 13 in the case where the target area consists of 3×3 pixels. The pixels labeled with “a”, “b” and “c” are the selection pixels, and the pixel labeled with “b” is the target pixel. Note that FIG. 6A shows the selection pixels corresponding to the gradient direction DIR1₃, FIG. 6B shows the selection pixels corresponding to the gradient direction DIR2₃, FIG. 6C shows the selection pixels corresponding to the gradient direction DIR3₃, and FIG. 6D shows the selection pixels corresponding to the gradient direction DIR4₃.

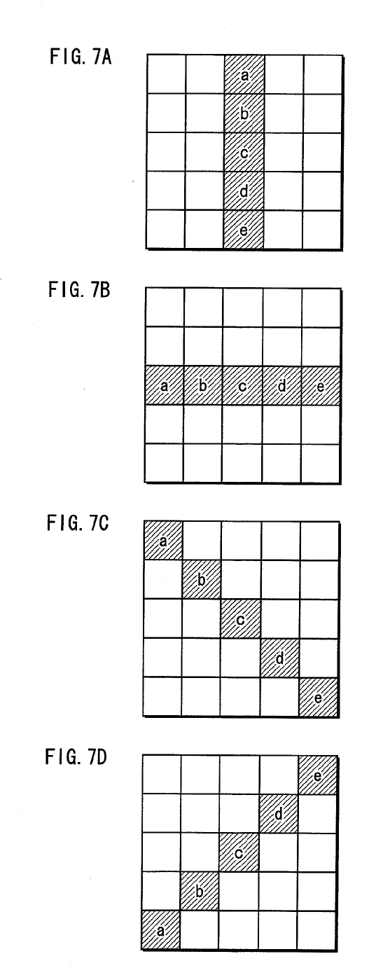

FIGS. 7A to 7D show the selection pixels to be selected by the selecting unit 13 in the case where the target area consists of 5×5 pixels. The pixels labeled with “a”, “b”, “c”, “d” and “e” are the selection pixels, and the pixel labeled with “c” is the target pixel. Note that FIG. 7A shows the selection pixels corresponding to the gradient direction DIR1₅, FIG. 7B shows the selection pixels corresponding to the gradient direction DIR2₅, FIG. 7C shows the selection pixels corresponding to the gradient direction DIR3₅, and FIG. 7D shows the selection pixels corresponding to the gradient direction DIR4₅.

The filter coefficient initialization unit 14 initializes filer coefficients respectively corresponding to the selection pixels, and outputs the initial values of the filter coefficients to the filter coefficient correction unit 16. Note that when initializing the filter coefficients, the filter coefficient initialization unit 14 performs normalization such that the sum of the initial values of the filter coefficients becomes 1.

For example, in the case where the target area consists of 3×3 pixels, the filter coefficient initialization unit 14 initializes filter coefficients Cₐ₃, C_{b3} and C_{c3} such that the sum of initial values Cₐ₃ᵢ, C_{b3i} and C_{c3i} of the filter coefficients Cₐ₃, C_{b3} and C_{c3} becomes 1 (i.e. Cₐ₃ᵢ+C_{b3i}+C_{c3i}=1). Note that the filter coefficients Cₐ₃, C_{b3} and C_{c3} respectively correspond to the selections pixels labeled with “a”, “b” and “c” in FIGS. 6A to 6D. The initial values of the filter coefficients satisfy, for example, Cₐ₃ᵢ=C_{b3i}=C_{c3i}, or C_{b3i}>Cₐ₃ᵢ=C_{c3i}. In the latter case, the degree of the bluer due to the denoising will be decreased. Note that the magnitude correlation among the initial values of the filter coefficients Cₐ₃, C_{b3} and C_{c3} is not necessarily the correlation shown above.

In the case where the target area consists of 5×5 pixels, the filter coefficient initialization unit 14 initializes filter coefficients Cₐ₅, C_{b5}, C_{c5}, C_{d5} and Cₑ₅ such that the sum of initial values Cₐ₅ᵢ, C_{b5i}, C_{c5i}, C_{d5i} and Cₑ₅ᵢ of the filter coefficients Cₐ₅, C_{b5}, C_{c5}, C_{d5} and Cₑ₅ becomes 1 (i.e. Cₐ₅ᵢ+C_{b5i}C_{c5i}+C_{d5i}+Cₑ₅ᵢ=1). Note that the filter coefficients Cₐ₅, C_{b5}, C_{c5}, C_{d5} and Cₑ₅ respectively correspond to the selections pixels labeled with “a”, “b”, “c”, “d” and “e” in FIGS. 7A to 7D. The initial values of the filter coefficients satisfy, for example, Cₐ₅ᵢ=C_{b5i}=C_{c5i}=C_{d5i}=Cₑ₅ᵢ, or C_{c5i}>C_{b5i}=C_{d5i}>Cₐ₅ᵢ=Cₑ₅ᵢ. In the latter case, the degree of the bluer due to the denoising will be decreased. Note that the magnitude correlation among the initial values of the filter coefficients Cₐ₅, C_{b5}, C_{c5}, C_{d5} and Cₑ₅ is not necessarily the correlation shown above.

The reference value determination unit 15 determines, for each of the selection pixels selected by the selecting unit 13 according to the selection-pixel information, a pixel (hereinafter called “reference pixel”) to be used for determining a reference value for correcting the filter coefficient corresponding to the pixel, based on a gradient direction received from the gradient direction detection unit 12. The reference value determination unit 15 calculates the reference value based on the pixel value of the determined reference pixel. Then, the reference value determination unit 15 outputs the reference values, calculated for the selection pixels respectively, to the filter coefficient correction unit 16.

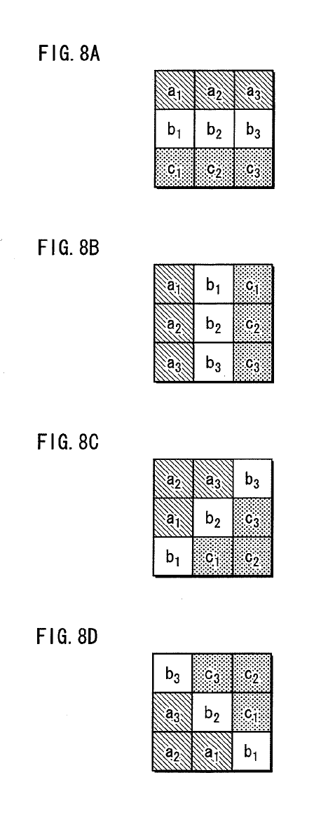

The following explains the calculation of the reference values, performed by the reference value determination unit 15 in the case where the target area consists of 3×3 pixels, with reference to FIGS. 8A to 8D. Note that FIGS. 8A to 8D respectively show the reference pixels for the gradient direction DIR1₃, the reference pixels for the gradient direction DIR2₃, the reference pixels for the gradient direction DIR3₃, and the reference pixels for the gradient direction DIR4₃. The pixels labeled with “a₁”, “a₂” and “a₃” shown in FIGS. 8A to 8D are the reference pixels relating to the selection pixel labeled with “a” shown in FIGS. 6A to 6D. The pixels labeled with “b₁”, “b₂” and “b₃” shown in FIGS. 8A to 8D are the reference pixels relating to the selection pixel labeled with “b” shown in FIGS. 6A to 6D. The pixels labeled with “c₁”, “c₂” and “c₃” shown in FIGS. 8A to 8D are the reference pixels relating to the selection pixel labeled with “c” shown in FIGS. 6A to 6D.

Regarding the gradient directions DIR1₃ and DIR2₃, the reference value determination unit 15 determines, as the reference pixels for each of the selection pixels, three pixels in the line that passes thorough the center point of the corresponding selection pixel and extends in the corresponding gradient direction received from the gradient direction detection unit 12 (See FIG. 8A and FIG. 8B).

Regarding the gradient directions DIR3₃ and DIR4₃, the reference value determination unit 15 determines, as the reference pixels for the selection pixel labeled with “b”, three pixels in the line that passes thorough the center point of the selection pixel and extends in the gradient direction received from the gradient direction detection unit 12. For each of the selection pixels labeled with “a” and “c”, the reference value determination unit 15 determines three pixels as the reference pixels, namely the selection pixel and the two pixels that are horizontally and vertically adjacent to the selection pixel (See FIG. 8C and FIG. 8D). Note that it is because 3×3 pixels are processed as a single object that the two pixels adjacent to the selection pixel are determined as the reference pixels for the selection pixels labeled with “a” and “c”. Alternatively, pixel values of pixels outside the target area may be acquired from the original-image memory 2, and pixels in the line that passes through the center point of the target pixel and extends in the gradient direction may be determined as the reference pixels.

Subsequently, the reference value determination unit 15 calculates the reference values for the selection pixels by the following expression (5), and outputs the calculated reference values to the filter coefficient correction unit 16.

[Math. 5]

Sₐ=αₐ×a₁+βₐ×a₂+γₐ×a₃

S_{b}=α_{b}×b₁+β_{b}×b₂+γ_{b}×b₃

S_{c}=α_{c}×c₁+β_{c}×c₂+γ_{c}×c₃ (5)

Note that Sₐ, S_{b} and S_{c} respectively denote the reference values for the selection pixels labeled with “a”, “b” and “c”. a₁, a₂ and a₃ respectively denote the pixel values of the referencepixels labeled with “a₁”, “a₂” and “a₃”. b₁, b₂ and b₃ respectively denote the pixel values of the reference pixels labeled with “b₁”, “b₂” and “b₃”. c₁, c₂ and c₃ respectively denote the pixel values of the reference pixels labeled with “c₁”, “c₂” and “c₃”. αₐ, βₐ, γₐ, α_{b}, β_{b}, γ_{b}, α_{c}, β_{c}, and γ_{c} are predetermined constant values. It is preferable that βₐ is equal to or greater than αₐ and γₐ. Also, it is preferable that β_{b} is equal to or greater than α_{b} and γ_{b}, and that β_{c} is equal to or greater than α_{c} and γ_{c}.

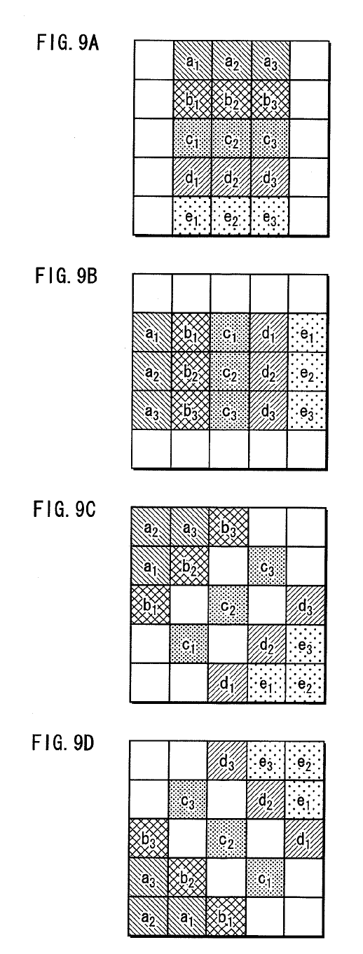

The following explains the calculation of the reference values, performed by the reference value determination unit 15 in the case where the target area consists of 5×5 pixels, with reference to FIGS. 9A to 9D. Note that FIGS. 9A to 9D respectively show the reference pixels for the gradient direction DIR1₅, the reference pixels for the gradient direction DIR2₅, the reference pixels for the gradient direction DIR3₅, and the reference pixels for the gradient direction DIR4₅. The pixels labeled with “a₁”, “a₂” and “a₃” shown in FIGS. 9A to 9D are the reference pixels relating to the selection pixel labeled with “a” shown in FIGS. 7A to 7D. The pixels labeled with “b₁”, “b₂” and “b₃” shown in FIGS. 9A to 9D are the reference pixels relating to the selection pixel labeled with “b” shown in FIGS. 7A to 7D. The pixels labeled with “c₁”, “c₂” and “c₃” shown in FIGS. 9A to 9D are the reference pixels relating to the selection pixel labeled with “c” shown in FIGS. 7A to 7D. The pixels labeled with “d₁”, “d₂” and “d₃” shown in FIGS. 9A to 9D are the reference pixels relating to the selection pixel labeled with “d” shown in FIGS. 7A to 7D. The pixels labeled with “e₁”, “e₂” and “e₃” shown in FIGS. 9A to 9D are the reference pixels relating to the selection pixel labeled with “e” shown in FIGS. 7A to 7D.

Regarding the gradient directions DIR1₅ and DIR2₅, the reference value determination unit 15 determines, as the reference pixels for each of the selection pixels, three pixels in the line that passes thorough the center point of the corresponding selection pixel and extends in the corresponding gradient direction received from the gradient direction detection unit 12 (See FIG. 9A and FIG. 9B).

Regarding the gradient directions DIR3₅ and DIR4₅, the reference value determination unit 15 determines, as the reference pixels for each of the selection pixel labeled with “b”, “c” and “d”, three pixels in the line that passes thorough the center point of the selection pixel and extends in the gradient direction received from the gradient direction detection unit 12. For each of the selection pixels labeled with “a” and “e”, the reference value determination unit 15 determines three pixels as the reference pixels, namely the selection pixel and the two pixels that are horizontally and vertically adjacent to the selection pixel (See FIG. 9C and FIG. 9D). Note that it is because 5×5 pixels are processed as a single object that the two pixels adjacent to the selection pixel are determined as the reference pixels for the selection pixels labeled with “a” and “e”. Alternatively, pixel values of pixels outside the target area may be acquired from the original-image memory 2, and pixels in the line that passes through the center point of the target pixel and extends in the gradient direction may be determined as the reference pixels.

Subsequently, the reference value determination unit 15 calculates the reference values for the selection pixels by the following expression (6), and outputs the calculated reference values to the filter coefficient correction unit 16.

[Math. 6]

Sₐ=αₐ×a₁+βₐ×a₂+γₐ×a₃

S_{b}=α_{b}×b₁+β_{b}×b₂+γ_{b}×b₃

S_{c}=α_{c}×c₁+β_{c}×c₂+γ_{c}×c₃

S_{d}=α_{d}×d₁+β_{d}×d₂+γ_{d}×d₃

Sₑ=αₑ×e₁+βₑ×e₂+γₑ×e₃ (6)

Note that Sₐ, S_{b}, S_{c}, S_{d} and Sₑ respectively denote the reference values for the selection pixels labeled with “a”, “b”, “c”, “d” and “e”. a₁, a₂ and a₃ respectively denote the pixel values of the reference pixels labeled with “a₁”, “a₂” and “a₃”. b₁, b₂ and b₃ respectively denote the pixel values of the reference pixels labeled with “b₁”, “b₂” and “b₃”. c₁, c₂ and c₃ respectively denote the pixel values of the reference pixels labeled with “c₁”, “c₂” and “c₃”. d₁, d₂ and d₃ respectively denote the pixel values of the reference pixels labeled with “d₁”, “d₂” and “d₃” . e₁, e₂ and e₃ respectively denote the pixel values of the reference pixels labeled with “e₁”, “e₂” and “e₃”. αₐ, βₐ, γₐ, α_{b}, β_{b}, γ_{b}, α_{c}, β_{c}, γ_{c}, α_{d}, β_{d}, γ_{d}, αₑ, βₑ, and γₑ are predetermined constant values. It is preferable that βₐ is equal to or greater than αₐ and γₐ. Also, it is preferable that β_{b} is equal to or greater than α_{b} and γ_{b}, and that β_{c} is equal to or greater than α_{c} and γ_{c}. Also, it is preferable that β_{d} is equal to or greater than α_{d} and γ_{d}, and that βₑ is equal to or greater than αₑ and γₑ.

In this way, it is possible to perform correction of the filter coefficients while reducing the influence of noise by considering not only the selection pixels selected in the direction orthogonal to the gradient direction, but also the pixels around the selection pixels . As a result, it is possible to suppress the occurrence of the blurring around the edges of the image due to the filtering.

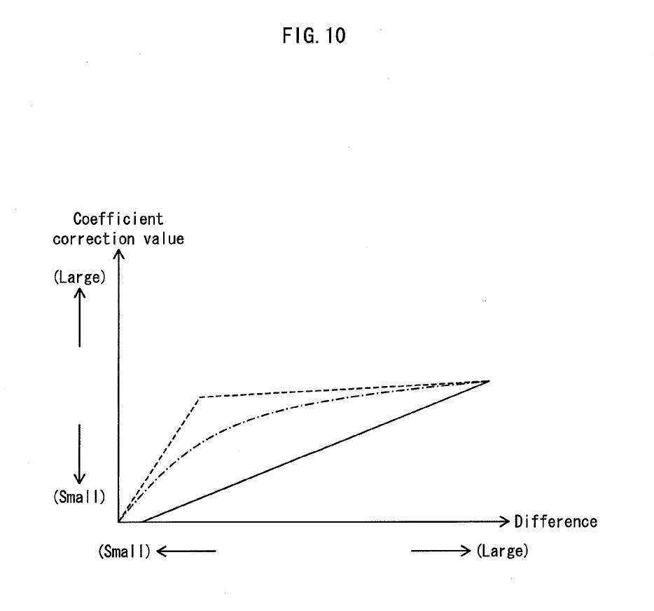

The filter coefficient correction unit 16 calculates, for each of the selection pixels selected by the selecting unit 13 except for the target pixel, the absolute value of the difference (hereinafter simply referred to as “the difference”) between the reference value for the target pixel and the reference value for the corresponding selection pixel. Based on the calculated difference, the filter coefficient correction unit 16 obtains a coefficient correction value for correction of the filter coefficient. In this embodiment, the filter coefficient correction unit 16 obtains the coefficient correction value for the calculated difference by using one of the relationships between the difference and the coefficient correction value shown in FIG. 10. In FIG. 10, the horizontal axis shows the difference and the vertical axis shows the coefficient correction value. The full line shows an example of difference correction with a line. The dotted line shows an example of difference correction with a broken line. The dashed-dotted line shows an example of difference correction with a curve line. For example, the filter coefficient correction unit 16 uses the relationship between the difference and the coefficient correction value represented with the dashed-dotted line in FIG. 10.

Next, the filter coefficient correction unit 16 calculates, for each of the selection pixels selected by the selecting unit 13 except for the target pixel, a corrected value of the corresponding filter coefficient by subtracting the obtained coefficient correction value from the initial value of the filter coefficient. For the target pixel out of the selection pixels, the filter coefficient correction unit 16 calculates a corrected value of the corresponding filter coefficient by adding all the coefficient correction values calculated for the selection pixels except the target pixel, to the initial value of the filter coefficient corresponding to the target pixel. Then, the filter coefficient correction unit 16 outputs the corrected values of the filter coefficients respectively corresponding to the selection pixels, to the pixel value calculation unit 17.

For example, in the case where the target area consists of 3×3 pixels, the filter coefficient correction unit 16 calculates the absolute value of a deference |S_{b}−Sₐ|, which is the difference between the reference value S_{b} for the selection pixel (target pixel) labeled with “b” and the reference value Sₐ for the selection pixel labeled with “a”. Then the filter coefficient correction unit 16 calculates a coefficient correction value C_{ba3} for the difference |S_{b}−Sₐ| from the relationship between the difference and the coefficient correction value shown in FIG. 10. Also, the filter coefficient correction unit 16 calculates the absolute value of a deference |S_{b}−S_{c}|, which is the difference between the reference value S_{b} for the selection pixel (target pixel) labeled with “b” and the reference value S_{c} for the selection pixel labeled with “c”. Then the filter coefficient correction unit 16 calculates a coefficient correction value C_{bc3} for the difference |S_{b}−S_{c}| from the relationship between the difference and the coefficient correction value shown in FIG. 10.

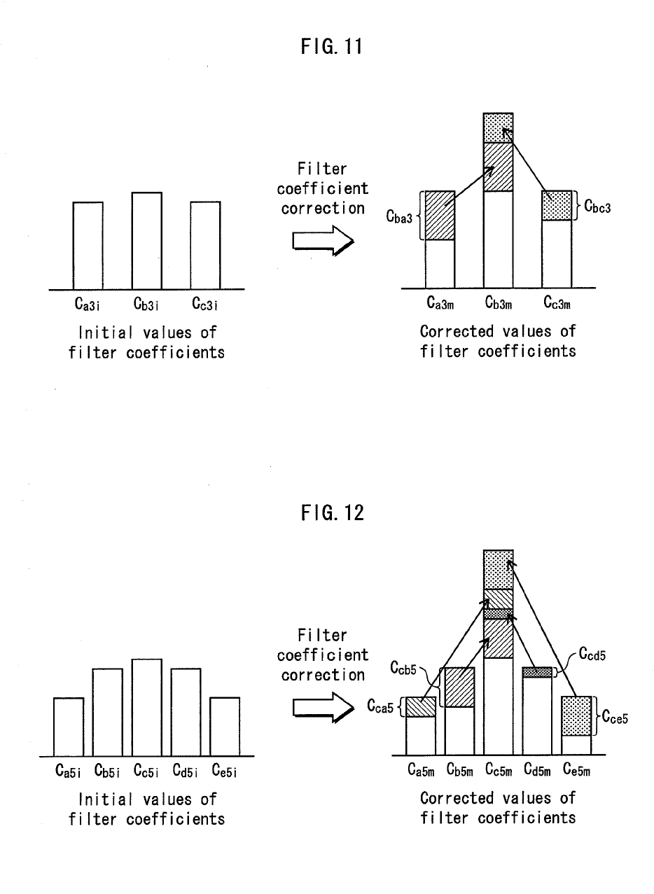

After that, the filter coefficient correction unit 16 calculates corrected values of the filter coefficients Cₐ₃, C_{b3}, and C_{c3} corresponding to the selection pixels, by the following expression (7). This correction is illustrated in FIG. 11.

[Math. 7]

Cₐ₃ₘ=Cₐ₃ᵢ−C_{ba3}

C_{b3m}=C_{b3i}+C_{ba3}+C_{bc3}

C_{c3m}=C_{c3i}−C_{bc3} (7)

Note that Cₐ₃ₘ, C_{b3m} and C_{c3m} are corrected values of the filter coefficients Cₐ₃, C_{b3} and C_{c3}, respectively.

In the case where the target area consists of 5×5 pixels, the filter coefficient correction unit 16 calculates the absolute value of a deference |S_{c}−Sₐ|, which is the difference between the reference value S_{c} for the selection pixel (target pixel) labeled with “c” and the reference value Sₐ for the selection pixel labeled with “a”. Then the filter coefficient correction unit 16 calculates a coefficient correction value C_{ca5} for the difference |S_{c}−Sₐ| from the relationship between the difference and the coefficient correction value shown in FIG. 10. Also, the filter coefficient correction unit 16 calculates the absolute value of a deference |S_{c}−S_{b}|, which is the difference between the reference value S_{c} for the selection pixel (target pixel) labeled with “c” and the reference value S_{b} for the selection pixel labeled with “b”. Then the filter coefficient correction unit 16 calculates a coefficient correction value C_{cb5} for the difference |S_{c}−S_{b}| from the relationship between the difference and the coefficient correction value shown in FIG. 10. Also, the filter coefficient correction unit 16 calculates the absolute value of a deference |S_{c}−S_{d}|, which is the difference between the reference value S_{c} for the selection pixel (target pixel) labeled with “c” and the reference value S_{d} for the selection pixel labeled with “d”. Then the filter coefficient correction unit 16 calculates a coefficient correction value C_{cd5} for the difference |S_{c}−S_{d}| from the relationship between the difference and the coefficient correction value shown in FIG. 10. Also, the filter coefficient correction unit 16 calculates the absolute value of a deference |S_{c}−Sₑ|, which is the difference between the reference value S_{c} for the selection pixel (target pixel) labeled with “c” and the reference value Sₑ for the selection pixel labeled with “e”. Then the filter coefficient correction unit 16 calculates a coefficient correction value C_{ce5} for the difference |S_{c}−Sₑ| from the relationship between the difference and the coefficient correction value shown in FIG. 10.

After that, the filter coefficient correction unit 16 calculates corrected values of the filter coefficients Cₐ₅, C_{b5}, C_{c5} C_{d5} and Cₑ₅ corresponding to the selection pixels, by the following expression (8). This correction is illustrated in FIG. 12.

[Math. 8]

Cₐ₅ₘ=Cₐ₅ᵢ−C_{ca5}

C_{b5m}=C_{b5i}−C_{cb5}

C_{c5m}=C_{c5i}−C_{ca5}+C_{cb5}+C_{cd5}+C_{ce5}

C_{d5m}=C_{d5i}−C_{cd5}

Cₑ₅ₘ=Cₑ₅ᵢ−C_{ce5} (8)

Note that Cₐ₅ₘ, C_{b5m}, C_{c5m}, C_{d5m} and Cₑ₅ₘ are corrected values of the filter coefficients Cₐ₅, C_{b5}, C_{c5}, C_{d5} and Cₑ₅ respectively.

In the case where any of the corrected values of the filter coefficients is a negative value, the filter coefficient correction unit 16 further corrects the corrected value such that the negative filter coefficient becomes 0, and also corrects the corrected value of the filter coefficient corresponding to the target pixel by adding the negative value.

As explained above, the filter coefficient correction with use of the reference values for the selection pixels decreases the filtering effect on a part of the image where the pixel values vary widely, which is, for example, a part where a large edge component is contained. As a result, the filter coefficient correction reduces the blurring around the edges of the image.

The pixel value calculation unit 17 multiplies, for each of the selection pixels selected by the selecting unit 13, the pixel value of the selection pixel by the corrected value, corrected by the filter coefficient correction unit 16, of the filter coefficient corresponding to the selection pixel. Then the pixel value calculation unit 17 sums up all the values obtained through the multiplications to obtain an output pixel value of the target pixel. The pixel value calculation unit 17 outputs the output pixel value of the target pixel to the pixel value output unit 18.

For example, in the case where the target area consists of 3×3 pixels, the pixel value calculation unit 17 calculates an output pixel value OUT(x, y) for the target pixel at (x, y) by the following expression (9).

[Math. 9]

OUT(x, y)=a×Cₐ₃ₘ+b×C_{b3m}+c×C_{c3m} (9)

Note that a, b and c are the pixel values of the selection pixels labeled with “a”, “b” and “c” respectively.

In the case where the target area consists of 5×5 pixels, the pixel value calculation unit 17 calculates an output pixel value OUT(x, y) for the target pixel at (x, y) by the following expression (10).

OUT(x, y)=a×Cₐ₅ₘ+b×C_{b5m}+c×C_{c5m}+d×C_{d5m}+e×Cₑ₅ₘ (10)

Note that a, b, c, d and e are the pixel values of the selection pixels labeled with “a”, “b”, “c”, “d” and “e” respectively.

The pixel value output unit 18 writes the output pixel value OUT (x, y), received from the pixel value calculation unit 17, into the processed-image memory 3.

### <Operation of Denoising Unit 4>

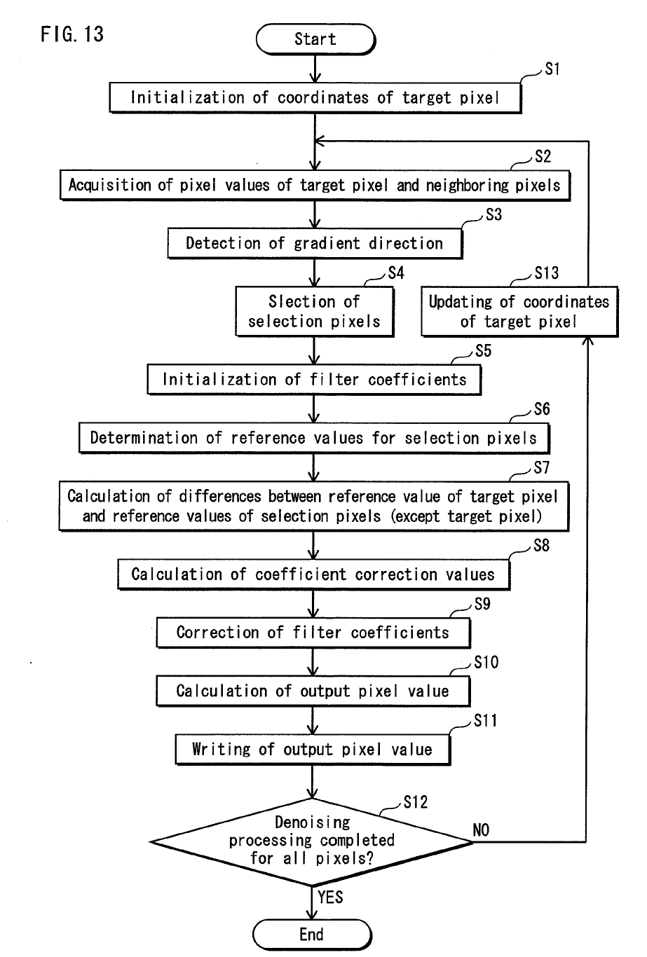

The following describes the denoising processing performed by the denoising unit 4 shown in FIG. 2, with reference to FIG. 13. FIG. 13 is a flowchart showing the procedures for the denoising processing performed by the denoising unit 4.

The pixel value acquisition unit 11 initializes the coordinates of the target pixel to be (x, y) (Step S1). The initial coordinates are, for example, (0, 0).

The pixel value acquisition unit 11 acquires, from the original-image memory 2, the pixel values of the pixels (the target pixel and the neighboring pixels) contained in the target area determined according to the position of the target pixel (Step S2). The gradient direction detection unit 12 detects the gradient direction of the pixel values in the target area, based on the pixel values of the pixels in the target area acquired in Step S2 (Step S3). The selecting unit 13 selects selection pixels from among the pixels contained in the target area, based on the result of the gradient direction detection in Step S3 (Step S4).

The filter coefficient initialization unit 14 initializes the filter coefficients corresponding to the selection pixels selected in Step S4 (Step S5). The reference value determination unit 15 determines reference values for the selection pixels selected in Step S4 (Step S6). The filter coefficient correction unit 16 calculates, for each of the selection pixels except the target pixel, the absolute value of the difference between the reference value of the target pixel and the reference value of the selection pixel (Step S7), and calculates coefficient correction values based on the differences (Step S8). Then, the filter coefficient correction unit 16 corrects the filter coefficients corresponding to the selection pixels, based on the coefficient correction values obtained in Step S8 (Step S9). The pixel value calculation unit 17 calculates the output pixel value of the target pixel, based on the pixel values of the selection pixels and the corrected filter coefficients (Step S10). The pixel value output unit 18 writes the output pixel value of the target pixel, obtained in Step S10, into the processed-image memory 3 (Step S11).

The pixel value acquisition unit 11 judges whether the denoising processing has been performed on all the pixels of the original image in the original-image memory 2 to be processed (Step S12). If the denoising processing has not been performed on all the pixels (Step S12: NO), the pixel value acquisition unit 11 updates the coordinates of the target position to be the coordinates of an unprocessed pixel (Step S13), and performs Step S2. If the denoising processing has been performed on all the pixels (Step S12: YES), the denoising processing shown in FIG. 13 completes.

According to the embodiment described above, it is possible to perform the denoising while preserving the edges of an image, with a smaller amount of calculations and a smaller circuit size than a bilateral filter. In this way, the embodiment described above achieves effects similar to those of bilateral filters, with smaller amount of calculations.

### <<Modification>>

### <Computer>

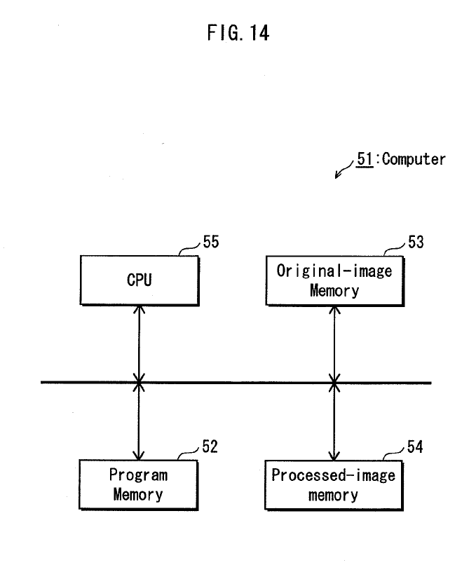

The following explains a computer for executing the denoising processing of the image denoising device 1, with reference to FIG. 14. FIG. 14 shows the structure of the computer pertaining to this modification.

A computer 51 includes a program memory 52, an original-image memory 53, a processed-image memory 54 and a CPU (Central Processing Unit) 55.

As the program memory 52, the original-image memory 53, and the processed-image memory 54, a semiconductor memory can be used, for example. The program memory 52 stores an image denoising program describing processing procedures that are equivalent to the procedures for the denoising processing performed by the denoising device 1 explained above. The original-image memory 53 stores an original image. The processed-image memory 54 stores a processed image that has been subject to the denoising processing by the CPU 55 executing the image denoising program.

The CPU 55 reads the image denoising program from the program memory 52 and executes the image denoising program. Thus the CPU 55 removes noise from the original image stored in the original-image memory 53. The CPU 55 writes the processed image, obtained through the denoising, into the processed-image memory 54.

Note that a DSP (Digital Signal Processor), for example, may be used instead of the CPU.

### <Handling of Color Images>

The embodiment described above is designed to process gray scale images in which each pixel has only one pixel value and images in which each pixel has only a brightness value. However, the present invention is not limited to this. For example, the present invention may process images having brightness values (Y) and color differences (Cb, Cr) as pixel values.

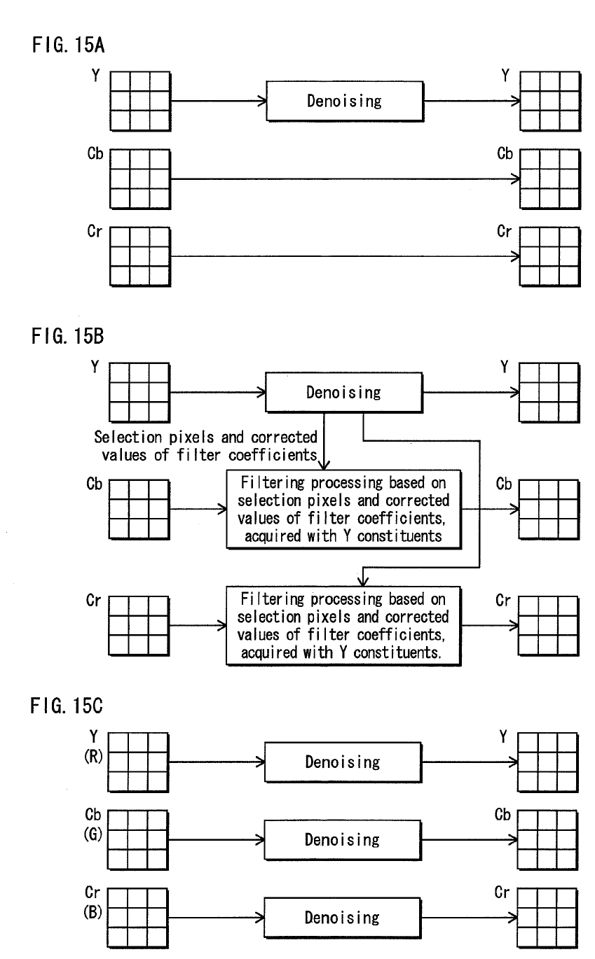

The following explains denoising processing in the case of a color image, with reference to FIGS. 15A to 15C. FIGS. 15A to 15C illustrate example applications of denoising processing on a color image.

According to an example application shown in FIG. 15A, the image denoising device only performs the denoising processing, explained above as to the embodiment, only on the brightness components (Y). The image denoising device copies the Cb and Cr components from the original-image memory to the processed-image memory without change. That is, the image denoising device performs the denoising processing only on the brightness (Y) components as a human is sensitive to noise contained therein, and does not perform the denoising processing on the color difference components (Cb, Cr). Thus, it is possible to remove noise from the brightness (Y) components to which a human is sensitive, while reducing the amount of processing required for the denoising.

According to an example application shown in FIG. 15B, the image denoising device performs, for each target pixel, selection of selection pixels and calculation of corrected values of their filter coefficients by using the brightness (Y) components. After that, the image denoising device calculates the output value of the brightness (Y) component that is to be output to the processed-image memory, based on the brightness (Y) components of the selection pixels and the corrected values of the filter coefficients. Concurrently, the image denoising device calculates the output value of the Cb component that is to be output to the processed-image memory, based on the Cb components of the selection pixels selected with use of the brightness (Y) components and the corrected values of the filter coefficients obtained with use of the brightness (Y) components. Also, the image denoising device calculates the output value of the Cr component that is to be output to the processed-image memory, based on the Cr components of the selection pixels selected with use of the brightness (Y) components and the corrected values of the filter coefficients obtained with use of the brightness (Y) components. Thus, it is also possible to perform denoising regarding the color difference, while reducing the amount of processing required for the denoising.

According to an example application shown in FIG. 15C, the image denoising device performs the denoising, explained above as to the embodiment, for the brightness components (Y), the Cb components and the Cr components, individually. Thus the denoising is performed on the brightness values (Y) and the color differences (Cb, Cr) together, which can lead to a preferable result. Further, the denoising processing is applicable to RGB and XYZ color spaces.

### <Iterated Executions>

In view of the processing amount and the effect of the denoising processing, it is preferable that the denoising processing pertaining to the embodiment described above is performed on 3×3 or 5×5 pixels including the target pixel at the center. However, there is a possibility that processing in units of 3×3 or 5×5 pixels can not remove noise that covers a widespread area, because the filtering processing can affect only a small area. Thus, to remove a widespread noise, the denoising processing may be performed again on the processed image stored in the processed-image memory 3. Note that the number of iterations of the denoising processing on the processed image may be changed as appropriate.

With such iterated executions, it is possible to remove a widespread noise. Further, since the denoising processing preserves the edges of images, it is possible to preserve the edges even if the processing is performed repeatedly. Thus, it is possible to gradually remove noise on an area other than the edges while preserving the edges.

In the case of repeating the denoising processing, the initial values of the filter coefficients, for example, maybe gradually changed. Alternatively, the gradient of the graph shown in FIG. 10, which is for the correction according to the absolute value of the difference between the reference values, may be gradually changed. For example, the initial denoising processing may be performed with even filter coefficients (i.e. the filter coefficients corresponding to the selection pixels are equal to each other) and a gentle gradient of the graph for the correction to perform filtering having a great effect, and the denoising processing for the second time and later may be performed with gradually decreased filter effects.

### <<Supplemental Descriptions>>

The present invention is not limited to the embodiment described above. For example, the following modifications may be made.

(1) According to the embodiment described above, the filter coefficient initialization unit 14 performs normalization such that the sum of the initial values of the filter coefficients becomes 1. However, the present invention is not limited to this. For example, the filter coefficient correction unit 16 may perform normalization such that the sum of the corrected values of the filter coefficients becomes 1.

(2) According to the embodiment described above, the filter coefficient initialization unit 14 initializes the filter coefficients to be predetermined values. However, the present invention is not limited to this. For example, the filter coefficient initialization unit 14 may initialize the filter coefficients such that the initial values of the filter coefficients vary for each target pixel. For example, in the case where another type of denoising processing is performed before the denoising processing pertaining to the embodiment above, the filter coefficient initialization unit 14 may change the initial values of the filter coefficients by using the results of the previous denoising processing. Also, in the case of repeating the denoising processing pertaining to the embodiment, the filter coefficient initialization unit 14 may change the initial values of the filter coefficients by using the results of denoising processing performed in the past (e.g. the previous processing). As a result, the image denoising device is capable of effectively performing the denoising processing while reducing the blurring.

(3) In the embodiment above, in the case of 3×3 pixels, the constant values α_{b} and γ_{b} may be set to 0 and the constant value β_{b} may be set to 1. The constant values are used by the reference value determination unit 15. In the case of 5×5 pixels, the constant values α_{c} and γ_{c} may be set to 0 and the constant value β_{c} may be set to 1. As a result, the amount of the calculations required for the denoising processing can be reduced.

Note that in the case of the target pixel as a selection pixel, only the target pixel may be regarded as a reference pixel. This means S_{b}=b₂ in the case of 3×3 pixels, and S_{c}=c₂ in the case of 5×5 pixels.

(4) According to the embodiment above, pixel values of a plurality of reference pixels are used for determination of a reference value for each selection pixel. However, the present invention is not limited to this. For example, for each selection pixel, a reference value for the selection pixel may be used as the pixel value of the selection pixel.

(5) According to the embodiment above, the reference value determination unit 15 uses constant values. However, the present invention is not limited to this. Different value may be used according to the original image.

(6) According to the embodiment above, the number of reference values in the case of 5×5 pixels is three. However, the present invention is not limited to this. For example, the number of reference pixels may be five.

(7) According to the embodiment above, the coefficient correction values are calculated by using a graph in FIG. 10 showing the relation between the differences and the coefficient correction values. However, the present invention is not limited to this. For example, a function f (diff), which uses a difference (diff) as a variable may be prepared, and the coefficient correction values may be calculated by coefficient correction value=f(diff).

(8) According to the embodiment above, the target of the denoising processing is an original image stored in the original-image memory 2. However, the target of the denoising processing is not particularly limited. For example, the target of the denoising processing may be an image processed through another denoising processing.

(9) According to the embodiment above, the target area contains N×N pixels (Nis an odd number no less than 3), including the target pixel at the center. However, the present invention is not limited to this. For example, the target area may contain A×A pixels (A is an even number no less than 2). Further, the target area may contain B1×B2 (B1 and B2 are integers no less than 2 and different from each other).

The embodiment above may be structured as, typically, a LSI (Large Scale Integration) which is an integrated circuit. The constituent elements of the embodiment may be individually structured as single chips. Alternatively, a portion or all of the constituent elements may be structured as a single LSI.

Note that though LSI is used here, the circuit may be variously described as IC (Integrated Circuit), system LSI, super LSI or ultra LSI depending on the level of integration.

Note also that the technique used to make an integrated circuit does not have to be LSI. A special-purpose circuit or general-purpose processor may be used instead. LSI circuits whose configurations can be altered after production such as the programmable FPGA (Field Programmable Gate Array) or a reconfigurable processor whose circuit cell connections and settings are configurable may also be used.

Moreover, if, due to progress in the field of semiconductor technology or the derivation of another technology, a technology to replace LSI emerges, that technology may, as a matter of course, be used to integrate the functional block. The use of biotechnology, or the like is considered to be a possibility.

### INDUSTRIAL APPLICABILITY

The present invention is applicable to denoising processing for input to digital cameras and video movie recorders for example, and output from digital TVs for example. In particular, in the case of high-speed capturing with a high shutter speed, noise increases due to the sensitizing. The present invention is suitable as a device for effectively removing such noise.

1. An image denoising device comprising:
a gradient direction detection unit operable to detect a gradient direction of values of pixels contained in an area consisting of N×N pixels including a target pixel at the center of the area, where N is an odd number no less than 3;
a selecting unit operable to select N pixels as selection pixels from among the N×N pixels in a direction orthogonal to the gradient direction, the selection pixels including the target pixel;
a filter coefficient initialization unit operable to initialize filter coefficients respectively corresponding to the selection pixels;
a reference value determination unit operable to determine, for each of the selection pixels, a reference value for correction of the corresponding filter coefficient, based on pixel values of pixels determined by the gradient direction;
a filter coefficient correction unit operable to correct, for each of the selection pixels, an initial value of the corresponding filter coefficient, based on the corresponding reference value; and
a pixel value calculation unit operable to calculate an output pixel value of the target pixel, based on pixel values of the selection pixels and corrected values of the filter coefficients.

2. The image denoising device of claim 1, wherein
for each of the selection pixels, the reference value determination unit selects a plurality of pixels based on the gradient direction, and determines the corresponding reference value based on pixel values of the selected pixels.

3. The image denoising device of claim 1, wherein
for each of the selection pixels except the target pixel, the reference value determination unit selects a plurality of pixels based on the gradient direction, and determines the corresponding reference value based on pixel values of the selected pixels, and
for the target pixel as one of the selection pixels, the reference value determination unit determines the corresponding reference value based on a pixel value of the target pixel.

4. The image denoising device of claim 1, wherein
for each of the selection pixels, the reference value determination unit uses the corresponding pixel value as the corresponding reference value.

5. An image denoising method comprising:
a gradient direction detection step of detecting a gradient direction of values of pixels contained in an area consisting of N×N pixels including a target pixel at the center of the area, where N is an odd number no less than 3;
a selecting step of selecting N pixels as selection pixels from among the N×N pixels in a direction orthogonal to the gradient direction, the selection pixels including the target pixel;
a filter coefficient initialization step of initializing filter coefficients respectively corresponding to the selection pixels;
a reference value determination step of determining, for each of the selection pixels, a reference value for correction of the corresponding filter coefficient, based on pixel values of pixels determined by the gradient direction;
a filter coefficient correction step of correcting, for each of the selection pixels, an initial value of the corresponding filter coefficient, based on the corresponding reference value; and
a pixel value calculation step of calculating an output pixel value of the target pixel, based on pixel values of the selection pixels and corrected values of the filter coefficients.

6. An image denoising program for causing a computer to perform:
a gradient direction detection step of detecting a gradient direction of values of pixels contained in an area consisting of N×N pixels including a target pixel at the center of the area, where N is an odd number no less than 3;
a selecting step of selecting N pixels as selection pixels from among the N×N pixels in a direction orthogonal to the gradient direction, the selection pixels including the target pixel;
a filter coefficient initialization step of initializing filter coefficients respectively corresponding to the selection pixels;
a reference value determination step of determining, for each of the selection pixels, a reference value for correction of the corresponding filter coefficient, based on pixel values of pixels determined by the gradient direction;
a filter coefficient correction step of correcting, for each of the selection pixels, an initial value of the corresponding filter coefficient, based on the corresponding reference value; and
a pixel value calculation step of calculating an output pixel value of the target pixel, based on pixel values of the selection pixels and corrected values of the filter coefficients.
